(19) United States
(12) Patent Application Publication
(10) Pub. No.: US 2016/0300389 A1
(43) Pub. Date: Oct. 13, 2016

(54) CORRELATED IMMERSIVE VIRTUAL SIMULATION FOR INDOOR NAVIGATION

(71) Applicant: Exactigo, Inc., Vienna, VA (US)

(72) Inventors: Lloyd Franklin Glenn, III, Vienna, VA (US); Ann Christine Irvine, Eagle Point, OR (US)

(21) Appl. No.: 14/958,537

(22) Filed: Dec. 3, 2015

Related U.S. Application Data
(60) Provisional application No. 62/144,796, filed on Apr. 8, 2015.

(51) Int. Cl. G06T 19/00; G01C 21/16; G01C 21/20; G06T 17/00; G06T 15/00

(52) U.S. Cl. CPC G06T 19/006; G06T 17/00; G06T 15/005; G01C 21/206; G01C 21/165

(57) ABSTRACT

Some embodiments include a method of providing an immersive virtual simulation. An end-user device can retrieve a building model from a backend server system. The building model can characterize a building in the physical world and have multiple inter-related domains of characterization including at least a radiofrequency (RF) domain map and/or a physical domain map. The end-user device can render a virtual simulation world. The virtual simulation world can include a virtual building structure based on the physical domain map. The end-user can collect inertial sensor data, wireless communication transceiver data, and/or virtual sensor data. The end-user device can then determine a position of the end-user device based on the collected data relative to the RF map and/or the physical domain map.

### CROSS-REFERENCE TO RELATED APPLICATION(S)

This application claims the benefit of U.S. Provisional Patent Application No. 62/144,796, entitled “CORRELATED IMMERSIVE VIRTUAL SIMULATION FOR INDOOR NAVIGATION,” which was filed on Apr. 8, 2015, which is incorporated by reference herein in its entirety.

### TECHNICAL FIELD

Several embodiments relate to a location-based service system, and in particular, a location-based service.

### BACKGROUND

Mobile devices typically provide wireless geolocation services to the public as navigational tools. These services generally rely exclusively on a combination of global positioning service (GPS) geolocation technology and cell tower triangulation to provide a real-time position information for the user. Many users rely on these navigation services daily for driving, biking, hiking, and to avoid obstacles, such as traffic jams or accidents. Although popular and widely utilized, the technological basis of these services limits their applications to outdoor activities.

While the outdoor navigation space may be served by the GPS and cellular triangulation technologies, indoor geolocation/navigation space is far more challenging. The navigational services caused people to rely on their wireless devices to safely arrive at a general destination. Once inside, users are forced to holster their wireless device and revert to using antiquated (and often out-of-date) physical directories, information kiosks, printed maps, or website directions to arrive at their final destination.

The technical limitations of existing geolocation solutions have forced service providers to explore alternative technologies to solve the indoor navigation puzzle. Some systems rely on user-installed short-range Bluetooth beacons to populate the indoor landscape thus providing a network of known fixed emitters for wireless devices to reference. Other systems rely on costly user-installed intelligent Wi-Fi access points to assist wireless devices with indoor navigation requirements. Both of these “closed system” approaches seek to overcome the inherent difficulties of accurately receiving, analyzing, and computing useful navigation data in classic indoor RF environments by creating an artificial “bubble” where both emitters and receivers are controlled. These “closed” systems require large investments of resources when implemented at scale. While end-users are conditioned to expect wireless geolocation technologies to be ubiquitous and consistent, the closed systems typically are unable to satisfy this need.

### DISCLOSURE OVERVIEW

In several embodiments, an indoor navigation system includes a location service application running on an end-user device, a site survey application running on a surveyor device, and a backend server system configured to provide location-based information to facilitate both the location service application and the site survey application. The site survey application and the backend server system are able to characterize existing radiofrequency (RF) signatures in an indoor environment.

Part of the challenge with in-building navigation on wireless devices is the material diversity of the buildings themselves. Wood, concrete, metals, plastics, insulating foams, ceramics, paint, and rebar can all be found in abundance within buildings. These materials each create their own localized dielectric effect on RF energy. Attenuation, reflection, amplification, and/or absorption serve to distort the original RF signal. The additive and often cooperative effects of these building materials on RF signals can make creating any type of useful or predictive algorithm for indoor navigation difficult. Every building is different in its composition of material.

Despite this, the indoor navigation system is able to account for and use to its advantage these challenges. The indoor navigation system can be used in all building types despite differences in material composition. The indoor navigation system can account for the specific and unique characteristics of different indoor environment (e.g., different building types and configurations). The indoor navigation system can utilize the survey application to characterize existing/native RF sources and reflection/refraction surfaces using available RF antennas and protocols in mobile devices (e.g., smart phones, tablets, etc.).

For example, the surveyor device and the end-user device can each be a mobile device configured respectively by a special-purpose application running on its general-purpose operating system. The mobile device can have an operating system capable of running one or more third-party applications. For example, the mobile device can be a tablet, a wearable device, or a mobile phone.

In several embodiments, the indoor navigation system fuses RF data with input data generated by onboard sensors in the surveyor device or end-user device. For example, the onboard sensors can be inertial sensors, such as accelerometer, compass (e.g., digital or analog), a gyroscope, a magnetometer, or any combination thereof. The inertial sensors can be used to perform “dead reckoning” in areas of poor RF signal coverage. The indoor navigation system can leverage accurate and active 2D or 3D models of the indoor environment to interact with users. The indoor navigation system can actively adapt to changes in the building over its lifetime.

In several embodiments, the indoor navigation system fuses virtual sensor data with RF data and data generated by onboard sensors. A virtual sensor can be implemented by a physics simulation engine (e.g., a game engine). For example, the physics simulation engine can include a collision detection engine. Utilizing a probabilistic model (e.g., particle filter or other sequential Monte Carlo methods) of probable location and probable path, the physics simulation engine, and hence the virtual sensor, can compute weights to adjust computed locations using other sensors (e.g., inertial sensors, Wi-Fi sensors, cellular sensors, RF sensors, etc.). The indoor navigation system can leverage virtual sensors based on the active 2D or 3D models of the indoor environment. For example, the virtual sensor can detect objects and pathways in the 2D or 3D model. The virtual sensor can detect one or more paths between objects in the 2D or 3D model. The virtual sensor can compute the distance between one or more paths between objects (e.g., virtual objects and representation of physical objects, including humans) in the 2D or 3D model. The paths identified by the virtual sensor can be assigned a weighting factor by the indoor navigation system. The virtual sensor can detect collisions between objects in the 2D or 3D model. The virtual sensor fused with inertial sensors can provide an “enhanced dead reckoning” mode in areas of poor RF signal coverage. The virtual sensor receiving RF sensors and inertial sensors measurements can provide a further enhanced indoor navigation system.

These advantages are achieved via indoor geolocation processes and systems that can accurately recognize, interpret, and react appropriately based on the RF characteristics, physical characteristics, and/or 2D or 3D model(s) of a building. The indoor navigation system can dynamically switch and/or fuse data from different sensor suites available on the standard general-purpose mobile devices. The indoor navigation system can further complement this data with real time high resolution RF survey and mapping data available in the backend server system. This end-user device can then present a Virtual Simulation World constructed based on the data fusion. For example, the Virtual Simulation World is rendered as an active 2D or 3D indoor geolocation and navigation experience. The Virtual Simulation World includes both virtual objects and representations of physical objects or people.

For example, the indoor navigation system can create a dynamic three-dimensional (3D) virtual model of a physical building, using one or more physics simulation engines that are readily available on several mobile devices. A physics simulation engine can be designed to simulate realistic sense of the laws of physics to simulate objects. The physics simulation engine can be implemented via a graphics processing unit (GPU), a hardware chip set, a software framework, or any combination thereof. The physics simulation engine can also include a rendering engine capable of visually modeling virtual objects or representations of physical objects. This virtual model includes the RF and physical characteristics of the building as it was first modeled by a surveyor device or by a third party entity. The indoor navigation system can automatically integrate changes in the building or RF environment over time based on real-time reports from one or more instances of site survey applications and/or location service applications. Day to day users of the indoor navigation system interact with the 2D or 3D model either directly or indirectly and thus these interactions can be used to generate further data to update the 2D or 3D virtual model. The mobile devices (e.g., the surveyor devices or the end-user devices) can send model characterization updates to the backend server system (e.g., a centralized cloud service) on an “as needed” basis to maintain the integrity and accuracy of the specific building's 2D or 3D model. This device/model interaction keeps the characterizations of buildings visited up to date thus benefitting all system users.

The indoor navigation system can seamlessly feed building map data and high-resolution 2D or 3D RF survey data to instances of the location service application running on the end-user devices. The location service application on an end-user device can then use the 2D or 3D RF survey data and building map data to construct an environment for navigation and positioning engines to present to the users. The indoor navigation system can include a 2D or 3D Virtual Model (e.g., centralized or distributed) containing physical dimensions (geo-position, scale, etc.), unique RF characterization data (attenuation, reflection, amplification, etc.), and/or virtual model characterization data (obstacle orientation, pathway weighting, etc.). The fusion of these data sets enables the location service application on the end-user device to accurately determine and represent its own location within a Virtual World presented to the user. The indoor navigation system further enables one end-user device to synchronize its position and building models with other end-user devices to provide an even more accurate location-based or navigation services to the users. These techniques also enable an end-user device to accurately correlate its position in the 2D or 3D Virtual World with a real-world physical location (e.g., absolute or relative to known objects) of the end-user device. Thus, the user gets a live 2D or 3D Virtual indoor map/navigation experience based on accurate indoor geolocation data. In some embodiments, there is a 2D or 3D virtual world running on the physics simulation engine in the device, but the user interface can be a 2D map—or can just be data that is fed to another mapping application for use by that application.

In the event the end-user device detects that it is about to enter a radio-challenged area (e.g., dead-zone) of a building, the end-user device can seamlessly switch into an enhanced dead-reckoning mode, relying on walking pace and bearing data collected and processed by the end-user device's onboard sensor suite (e.g., inertial sensors, virtual sensor, etc.). In the Virtual World displayed to the end-user, this transition will be seamless and not require any additional actions/input.

The indoor geolocation/navigation solution described above enables a single application to function across many buildings and scenarios. With a rapidly growing inventory of building data, users ultimately would be able to rely on a single, multi-platform solution to meet their indoor navigation needs. A solution that works regardless of building type, network availability, or wireless device type; a solution that works reliably at scale, and a solution that does not require the installation/maintenance of costly proprietary “closed system” emitters in every indoor space.

Some embodiments of this disclosure have other aspects, elements, features, and steps in addition to or in place of what is described above. These potential additions and replacements are described throughout the rest of the specification

### BRIEF DESCRIPTION OF THE DRAWINGS

FIG. 1 is a block diagram illustrating an indoor navigation system, in accordance with various embodiments.

FIG. 2 is a block diagram illustrating a mobile device, in accordance with various embodiments.

FIG. 3 is an activity flow diagram of a location service application running on an end-user device, in accordance with various embodiments.

FIG. 4 is an activity flow diagram of a site survey application running on a surveyor device, in accordance with various embodiments.

FIG. 5A is a perspective view illustration of a virtual world rendered by the location service application, in accordance with various embodiments.

FIG. 5B is a top view illustration of a virtual simulation world rendered as a two-dimensional sheet by the location service application, in accordance with various embodiments.

FIG. 6 is a flow chart of a method of producing an immersive virtual world correlated to the physical world in real-time, in accordance with various embodiment.

FIG. 7 is a block diagram of an example of a computing device, which may represent one or more computing device or server described herein, in accordance with various embodiments.

FIG. 8 is a flow chart of a method of operating a surveyor device to generate or update a building model in a backend server system, in accordance with various embodiments.

FIG. 9 is an example of a user interface for an end-user device using the disclosed indoor navigation system to navigate through a known site, in accordance with various embodiments.

FIG. 10 is another example of a user interface for an end-user device using the disclosed indoor navigation system to navigate through a known site, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

### Glossary

“Physical” refers to real or of this world. Hence, the “Physical World” refers to the tangible and real world. A “Physical Map” is a representation (e.g., a numeric representation) of at least a part of the Physical World. “Virtual” refers to an object or environment that is not part of the real world and implemented via one or more computing devices. For example, several embodiments can include a “virtual object” or a “virtual world.” A virtual world environment can include virtual objects that interact with each other. In this disclosure, a “virtual simulation world” refers to a particular virtual environment that is configured to emulate some properties of the Physical World for purposes of providing one or more navigational or location-based services. The “virtual simulation world” can fuse properties from both the physical world and a completely virtual world. For example, the user can be represented as a virtual object (e.g., avatar) in a 2D or 3D model of a building which has been constructed to emulate physical properties (e.g., walls, walkways, etc. extracted from a physical map). The movement of the virtual object can be based upon the indoor navigation system—an algorithm based on physical characteristics of the environment. The virtual simulation world can be a virtual environment with virtual elements augmented by physical (“real or of this world”) elements. In some embodiments, the virtual simulation world comprises models (e.g., 2D or 3D models) of buildings, obstructions, point of interest (POI) markers, avatars, or any combination thereof. The virtual simulation world can also include representations of physical elements, such as 2D maps, WiFi profiles (signature “heat maps”), etc.

In some cases, a virtual object can be representative of a physical object, such as a virtual building representing a physical building. In some cases, a virtual object does not have a physical counterpart. A virtual object may be created by software. Visualizations of virtual objects and worlds can be created in order for real humans to see the virtual objects as 2D and/or 3D images (e.g., on a digital display). Virtual objects exist while their virtual world exists—e.g., while an application or process is being executed on a processing device that establishes the virtual world.

A “physical building” is a building that exists in the real/physical world. For example, humans can touch and/or walk through a physical building. A “virtual building” refers to rendition of one or more 2D or 3D electronic/digital model(s) of physical buildings in a virtual simulation world.

A “physical user” is a real person navigating through the real world. The physical user can be a user of a mobile application as described in embodiments of this disclosure. The physical user can be a person walking through one or more physical buildings while using the mobile application.

A “virtual user” refers to a rendition of a 2D or 3D model, representing the physical user, in a virtual simulation world. The virtual simulation world can include a virtual building corresponding to a physical building. The virtual user can interact with the virtual building in the virtual simulation world. A visualization of this interaction can be simultaneously provided to the physical user through the mobile application.

A “domain” refers to a type of sensed data analysis utilizing one type of sensor devices (e.g., standardized transceiver/antenna, motion sensor, etc.). For example, the “Wi-Fi Domain” pertains to data analysis of Wi-Fi radio frequencies; the “Cellular Domain” pertains to data analysis of cellular radio frequencies (e.g., cellular triangulation); the “GPS Domain” pertains to data analysis of latitude and longitude readings by one or more GPS modules. For example, the GPS Domain can include a GPS Device subdomain that pertains to data analysis of latitude and longitude readings as determined by an end-user mobile device. The GPS domain can include a GPS Access Point subdomain that pertains to data analysis of latitude and longitude readings as determined by a Wi-Fi access point. These domains can be referred to as “RF domains.”

For another example, a “Magnetic Domain” pertains to data analysis of magnetometer readings; a “Gyroscope Domain” pertains to data analysis of gyroscope readings from a gyroscope; and the “Accelerometer Domain” pertains to data analysis of kinetic movement readings from an accelerometer. A “Virtual Sensor Domain” pertains to data analysis utilizing a physics simulator engine. These domains can be referred to as “kinetic domains.” In other examples, an Image Recognition Domain pertains to data analysis of real-time images from a camera, an Audio Recognition Domain pertains to data analysis of real-time audio clips from a microphone, and a Near Field Domain pertains to data analysis of near field readings from a near field communication device (e.g., radiofrequency ID (RFID) device).

Several embodiments can be implemented in various semi-indoor applications. For example, indoor navigation can include navigation immediately outside of a building within a known “site” of related or connected buildings. In several embodiments, a “building model” can instead be a “site model,” including one or more models for one or more buildings. The surveyor application disclosed herein can survey exterior and/or interior of buildings so that the disclosed system can locate a user as the user approach a building. This enables the user to go out of the constraints of a single building. Accordingly, in several embodiments, a “building model” extends to a “site model” that can include several buildings. For example, in a medical office building, there can be four buildings that are in a site model. A user of the disclosed indoor navigation system can traverse from one region of the site to the next. For example, the site model can include a parking structure, a hospital, a court yard, an onsite street, or any combination thereof. The site model can include characterization of spaces between the buildings.

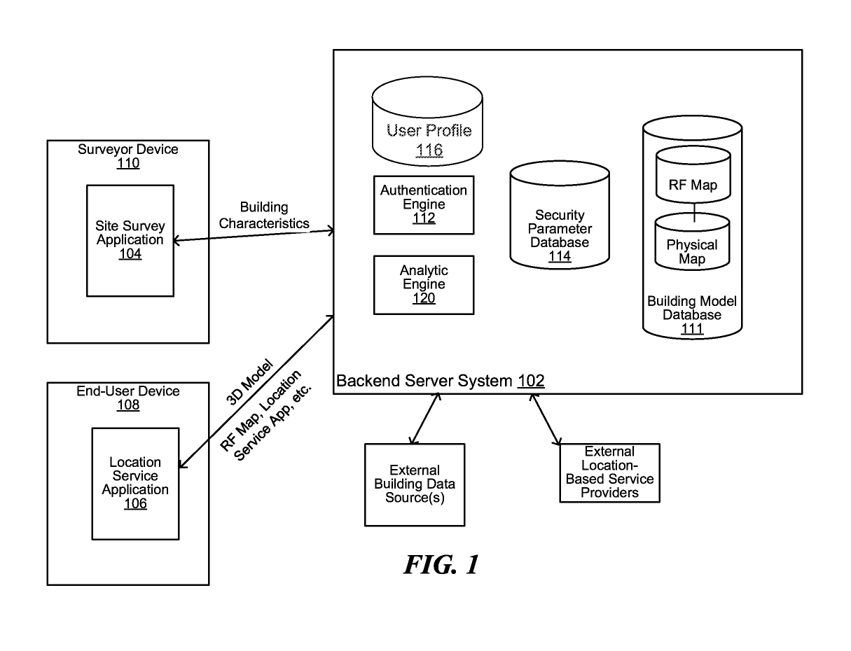

FIG. 1 is a block diagram illustrating an indoor navigation system 100, in accordance with various embodiments. The indoor navigation system 100 provides, in-buildings, location-based services via licensed commercial host applications or its own agent client applications running on end-user devices. For example, the indoor navigation system 100 includes a backend server system 102, a site survey application 104, and a location service application 106. Commercial customers, who would like to add the functionalities of the indoor navigation system 100, can couple to the indoor navigation system 100 through the use of an application programming interface (API) and/or embedding of a software development kit (SDK) in their native applications or services (e.g., web services). In several embodiments, the indoor navigation system 100 can support multiple versions and/or types of location service applications. For illustrative purposes, only the location service application 106 is shown in FIG. 1.

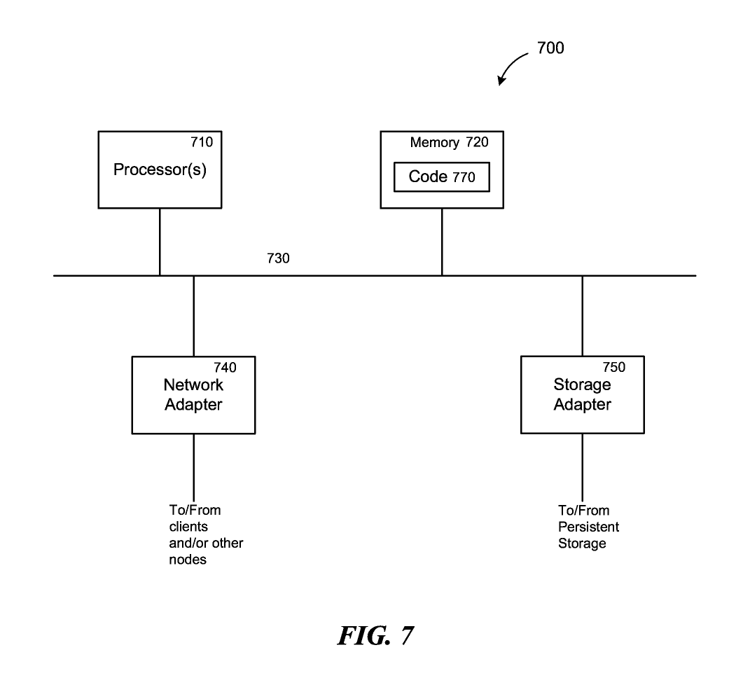

The backend server system 102 includes one or more computing devices, such as one or more instances of the computing device 700 of FIG. 7. The backend server system 102 provides data to deploy the location service application 106. The backend server system 102 can interact directly with the location service application 106 when setting up an active online session.

The backend server system 102 can provide data access to a building model database 111. For example, the building model database 111 can include a building model for an indoor environment (e.g., a building project, a public or semipublic building, etc.). The building model can include physical structure information (e.g., physical domains) and radio frequency (RF) information (e.g., RF domains), as well as other sensor data such as magnetic fields.

The backend server system 102 can provide a user authentication service via an authentication engine 112. The authentication engine 112 enables the backend server system 102 to verify that a user requesting building information from the building model database 111 is authorized for such access. The authentication engine 112 can access a security parameter database 114, indicating security settings (e.g., usage licenses and verification signatures) protecting one or more of the building models in the building model database 111. For example, the security settings can indicate which users are authorized for access. The backend server system 102 can provide a user profile database 116. The user profile database 116 can include user activity log (e.g., for error tracking and usage accounting purposes).

The location service application 106 is a client application (e.g., agent application) of the backend server system 102 that geo-locates an end-user device 108 (to which the location service application 106 is running on) based on an adaptive geolocation algorithm. In several embodiments, the end-user device 108 is a mobile device, such as a wearable device, a tablet, a cellular phone, a tag, or any combination thereof. The end-user device 108 can be an electronic device having a general-purpose operating system thereon that is capable of having other third-party applications running on the operating system. The adaptive geolocation algorithm can be based at least on a RF map (e.g., two-dimensional or three-dimensional RF map in the building model) associated with an indoor environment, the physical map (e.g., two-dimensional or three-dimensional physical map in the building model) of the indoor environment, sensor readings in the end-user device 108, or any combination thereof. The location service application 106 can receive sensor readings from one or more antennas (e.g., cellular antenna, Wi-Fi antenna, Bluetooth antenna, near field communication (NFC) antenna, or any combination thereof) and/or inertial sensors (e.g., an accelerometer, a gyroscope, a magnetometer, a compass, or any combination thereof). The adaptive geolocation algorithm combines all sensory data available to the end-user device 108 and maps the sensory data to the physical building map and the RF map.

In some embodiments, the location service application 106 can feed the sensory data to the backend server system 102 for processing via the adaptive geolocation algorithm. In some embodiments, the location service application 106 can compute the adaptive geolocation algorithm off-line (e.g., without the involvement of the backend server system 102). In some embodiments, the location service application 106 and the backend server system 102 can share responsibility for executing the adaptive geolocation algorithm (e.g., each performing a subset of the calculations involved in the adaptive geolocation algorithm). Regardless, the location service application 106 can estimate (e.g., calculated thereby or received from the backend server system 102) a current location of the end-user device 108 via the adaptive geolocation algorithm.

The backend server system 102 can include an analytic engine 120. The analytic engine 120 can perform least statistical analysis, predictive modeling, machine learning techniques, or any combination thereof. The analytic engine 120 can generate insights utilizing those techniques based on either stored (e.g., batch data), and/or real-time data collected from End User Device and/or Surveyor Device. Results from the analytics engine 120 may be used to update surveyor workflow (e.g., where to collect WiFi signal information based on location confusion metrics), update End User Device signal RF maps, update pathways in 2D or 3D models (e.g., based on pedestrian traffic), update weights on a sensor channel/domain, or any combination thereof.

In some embodiments, the estimated current location of the end-user device 108 can take the form of earth-relative coordinates (e.g., latitude, longitude, and/or altitude). In some embodiments, the estimated location can take the form of building relative coordinates that is generated based on a grid system relative to borders and/or structures in the building model.

The location service application 106 can report the estimated current location to a commercial host application either through mailbox updates or via asynchronous transactions as previously configured in the host application or the location service application 106. In some embodiments, the location service application 106 executes in parallel to the host application. In some embodiments, the location service application 106 is part of the host application.

In several embodiments, the location service application 106 can require its user or the host application's user to provide one or more authentication parameters, such as a user ID, a project ID, a building ID, or any combination thereof. The authentication parameters can be used for user identification and usage tracking.

In several embodiments, the location service application 106 is configured to dynamically adjust the frequency of sensor data collection (e.g., more or less often) to optimize device power usage. In some embodiments, the adaptive geolocation algorithm can dynamically adjust weights on the importance of different RF signals and/or motion sensor readings depending on the last known location of the end-user device 108 relative to the building model. The adjustments of these ways can also be provided to the end-user device via the backend server system 102. For example in those embodiments, the location service application 106 can adjust the frequency of sensor data collection from a sensor channel based on a current weight of the sensor channel computed by the adaptive geolocation algorithm.

In several embodiments, the location service application 106 can operate in an off-line mode. In those embodiments, the location service application 106 stores a building model or a portion thereof locally on the end-user device 108. For example, the location service application 106 can, periodically, according to a predetermined schedule, or in responsive to a use request, download the building model from the backend server system 102. In these embodiments, the location service application 106 can calculate the estimated current location without involvement of the backend server system 102 and/or without an Internet connection. In several embodiments, the downloaded building model and the estimated current location is encrypted in a trusted secure storage managed by the location service application 106 such that an unauthorized entity can neither access the estimated current location nor the building model.

The site survey application 104 is a data collection tool for characterizing an indoor environment (e.g., creating a new building model or updating an existing building model). For example, the site survey application 104 can sense and characterize RF signal strength corresponding to a physical map to create an RF map correlated with the physical map. The users of the site survey application 104 can be referred to as “surveyors.”

In several embodiments, the site survey application 104 is hosted on a surveyor device 110, such as a tablet, a laptop, a mobile phone, or any combination thereof. The surveyor device 110 can be an electronic device having a general-purpose operating system thereon that is capable of having other third-party applications running on the operating system. A user of the site survey application 104 can walk through/traverse the indoor environment, for example, floor by floor, as available, with the surveyor device 110 in hand. The site survey application 104 can render a drawing of the indoor environment as a whole and/or a portion of the indoor environment (e.g., a floor) that is being surveyed.

In some embodiments, the site survey application 104 indicates the physical location of the user at regular intervals on an interactive display overlaid on the rendering of the indoor environment. The site survey application 104 can continually sample from one or more sensors (e.g., one or more RF antennas, a global positioning system (GPS) module, an inertial sensor, or any combination thereof) in or coupled to the surveyor device 110 and store both the physical location and the sensor samples on the surveyor device 110. An “inertial sensor” can broadly referred to electronic sensors that facilitate navigation via dead reckoning. For example, an inertial sensor can be an accelerometer, a rotation sensor (e.g., gyroscope), an orientation sensor, a position sensor, a direction sensor (e.g., a compass), a velocity sensor, or any combination thereof.

In several embodiments, the surveyor device 110 does not require active connectivity to the backend server system 102. That is, the site survey application 104 can work offline and upload log files after sensor reading collection and characterization of an indoor environment have been completed. In some embodiments, the site survey application 104 can execute separately from the location service application 106 (e.g., running as separate applications on the same device or running on separate distinct devices). In some embodiments, the site survey application 104 can be integrated with the location service application 106.

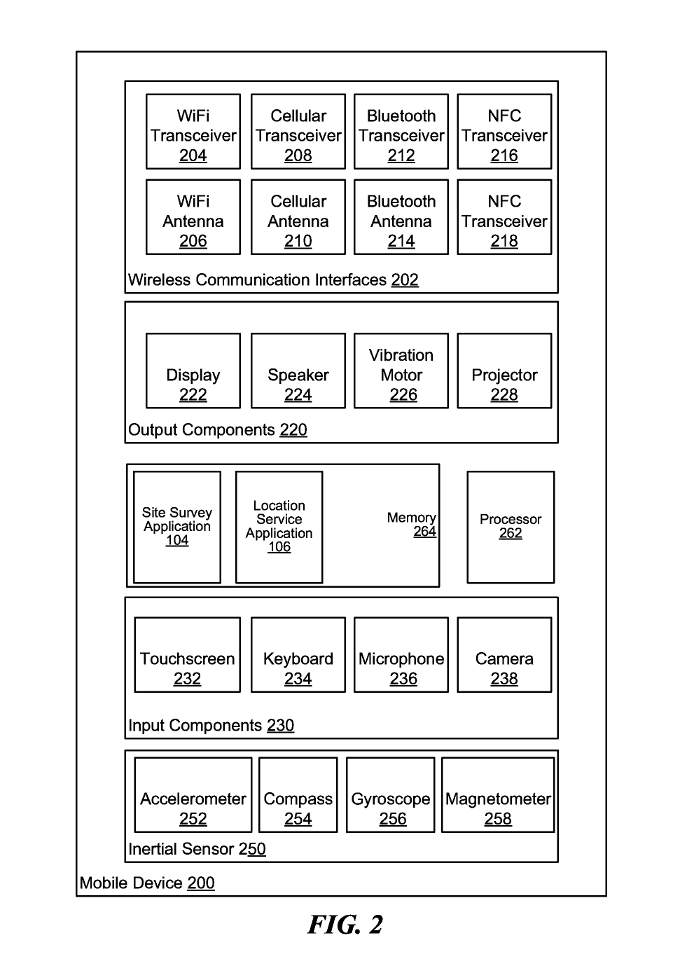

FIG. 2 is a block diagram illustrating a mobile device 200 (e.g., the end-user device 108 or the surveyor device 110 of FIG. 1), in accordance with various embodiments. The mobile device 200 can store and execute the location service application 106 and/or the site survey application 104. The mobile device 200 can include one or more wireless communication interfaces 202. For example, the wireless communication interfaces 202 can include a WiFi transceiver 204, a WiFi antenna 206, a cellular transceiver 208, a cellular antenna 210, a Bluetooth transceiver 212, a Bluetooth antenna 214, a near-field communication (NFC) transceiver 216, a NFC antenna 218, other generic RF transceiver for any protocol (e.g., software defined radio), or any combination thereof.

In several embodiments, the site survey application 104 or the location service application 106 can use at least one of the wireless communication interfaces 202 to communicate with an external computer network (e.g., a wide area network, such as the Internet, or a local area network) where the backend server system 102 resides. In some embodiments, the site survey application 104 can utilize one or more of the wireless communication interfaces 202 to characterize the RF characteristic of an indoor environment that the site survey application 104 is trying to characterize. In some embodiments, the location service application can take RF signal readings from one or more of the wireless communication interfaces 202 to compare to expected RF characteristics according to a building model that correlates a RF map to a physical map.

The mobile device 200 can include one or more output components 220, such as a display 222 (e.g., a touchscreen or a non-touch-sensitive screen), a speaker 224, a vibration motor 226, a projector 228, or any combination thereof. The mobile device 200 can include other types of output components. In some embodiments, the location service application 106 can utilize one or more of the output components 220 to render and present a virtual simulation world that simulates a portion of the Physical World to an end-user. Likewise, in some embodiments, the site survey application 104 can utilize one or more of the output components 220 to render and present a virtual simulation world while a surveyor is using the site survey application 104 to characterize an indoor environment (e.g., in the Physical World) corresponding to that portion of the virtual simulation world.

The mobile device 200 can include one or more input components 230, such as a touchscreen 232 (e.g., the display 222 or a separate touchscreen), a keyboard 234, a microphone 236, a camera 238, or any combination thereof. The mobile device 200 can include other types of input components. In some embodiments, the site survey application 104 can utilize one or more of the input components 230 to capture physical attributes of the indoor environment that the surveyor is trying to characterize. At least some of the physical attributes (e.g., photographs or videos of the indoor environment or surveyor comments/description as text, audio, or video) can be reported to the backend server system 102 and integrated into the building model. In some embodiments, the location service application 106 can utilize the input components 230 such that the user can interact with virtual objects within the virtual simulation world. In some embodiments, detection of interactions with a virtual object can trigger the backend server system 102 or the end-user device 108 to interact with a physical object (e.g., an external device) corresponding to the virtual object.

The mobile device 200 can include one or more inertial sensors 250, such as an accelerometer 252, a compass 254, a gyroscope 256, a magnetometer 258, other motion or kinetic sensors, or any combination thereof. The mobile device 200 can include other types of inertial sensors. In some embodiments, the site survey application 104 can utilize one or more of the inertial sensors 250 to correlate dead reckoning coordinates with the RF environment it is trying to survey. In some embodiments, the location service application 106 can utilize the inertial sensors 250 to compute a position via dead reckoning. In some embodiments, the location service application 106 can utilize the inertial sensors 250 to identify a movement in the Physical World. In response, the location service application 106 can render a corresponding interaction in the virtual simulation world and/or report the movement to the backend server system 102.

The mobile device 200 includes a processor 262 and a memory 264. The memory 265 stores executable instructions that can be executed by the processor 262. For example, the processor 262 can execute and run an operating system capable of supporting third-party applications to utilize the components of the mobile device 200. For example, the site survey application 104 or the location service application 106 can run on top of the operating system.

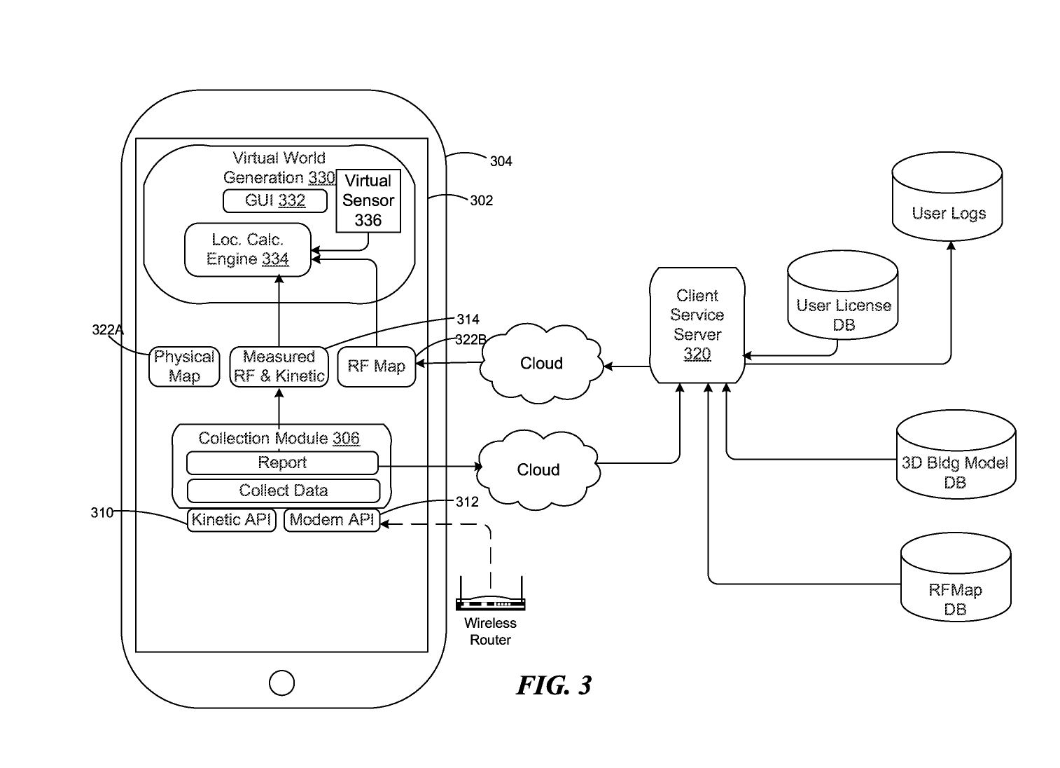

FIG. 3 is an activity flow diagram of a location service application 302 (e.g., the location service application 106 of FIG. 1) running on an end-user device 304 (e.g., the end-user device 108 of FIG. 1), in accordance with various embodiments. A collection module 306 of the location service application 302 can monitor and collect information pertinent to location of the end-user device 304 from one or more inertial sensors and/or one or more wireless communication interfaces. For example, the collection module 306 can access the inertial sensors through a kinetic application programming interface (API) 310. For another example, the collection module 306 can access the wireless communication interfaces through a modem API 312. In turn, the collection module 306 can store the collected data in a collection database 314 (e.g., measured RF attributes and inertial sensor readings). The collection module 306 can also report the collected data to a client service server 320 (e.g., a server in the backend server system 102 of FIG. 1)

The location service application 302 can also maintain a virtual building model including a physical map portion 322A, a RF map portion 322B, and/or other sensory domain maps (collectively as the “building model 322). In some embodiments, the physical map portion 322A and the RF map portion 322B are three dimensional. In other embodiments, the physical map portion 322A and the RF map portion 322B are represented by discrete layers of two-dimensional maps.

The location service application 302 can include a virtual simulation world generation module 330. The virtual simulation world generation module 330 can include a graphical user interface (GUI) 332, a location calculation engine 334, and a virtual sensor 336 (e.g., implemented by a physics simulation engine). The location calculation engine 334 can compute an in-model location of the end-user device 304 based on the building model 322 and the collected data in the collection database 314.

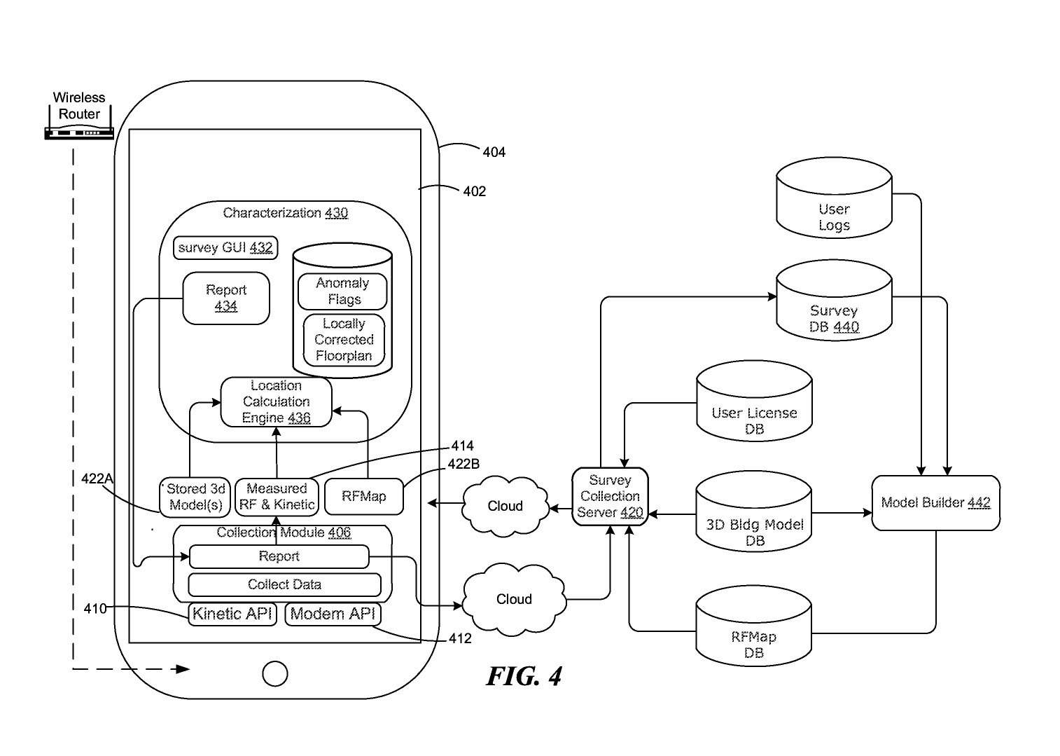

FIG. 4 is an activity flow diagram of a site survey application 402 (e.g., the site survey application 104 of FIG. 1) running on a surveyor device 404 (e.g., the surveyor device 110 of FIG. 1), in accordance with various embodiments. The site survey application 402 can include a collection module 406 similar to the collection module 306 of FIG. 3.

In turn, the collection module 406 can store the collected data in a collection database 414 (e.g., measured RF attributes and inertial sensor readings). The collection module 406 can also report the collected data to a survey collection server 420 (e.g., a server in the backend server system 102 of FIG. 1). The location service application 302 can also maintain a building model including a physical map portion 422A and a RF map portion 422B, and/or other sensory domain maps (collectively as the “building model 422), similar to the building model 322 of FIG. 3.

The site survey application 402 can include a characterization module 430. The characterization module 430 can include a survey GUI 432, a report module 434 (e.g., for reporting survey data and floorplan corrections to the survey collection server 420), a location calculation engine 436, and a virtual sensor 438 (e.g., a physics simulation engine). The location calculation engine 436 can function the same as the location calculation engine 334 of FIG. 3. The location calculation engine 436 can compute an in-model location of the surveyor device 404 based on the building model 422 and the collected data in the collection database 414. Based on the computed in-model location, the characterization module 430 can identify anomaly flags within the building model 422 that needs adjustment and produce a locally corrected building model (e.g., in terms of RF domains or kinetic domain). The virtual sensor 438 can be similar to the virtual sensor 336 of FIG. 3.

After the survey collection server 420 receives survey data (e.g., the collected data, anomaly flags and the locally corrected building model) from the surveyor device 404, the survey collection server 420 can store the survey data in a survey database 440. A model builder server 442 (e.g., the same or different physical server as the survey collection server 420) can build or update the building model based on the survey data. For example, the model builder server 442 can update the RF map or the physical map. In some embodiments, the model builder server 442 can further use user data from the end-user devices reported overtime to update the building model.

Functional components (e.g., engines, modules, and databases) associated with devices of the indoor navigation system 100 can be implemented as circuitry, firmware, software, or other functional instructions. For example, the functional components can be implemented in the form of special-purpose circuitry, in the form of one or more appropriately programmed processors, a single board chip, a field programmable gate array, a network-capable computing device, a virtual machine, a cloud computing environment, or any combination thereof. For example, the functional components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the functional components may operate individually and independently of other functional components. Some or all of the functional components may be executed on the same host device or on separate devices. The separate devices can be coupled through one or more communication channels (e.g., wireless or wired channel) to coordinate their operations. Some or all of the functional components may be combined as one component. A single functional component may be divided into sub-components, each sub-component performing separate method step or method steps of the single component.

In some embodiments, at least some of the functional components share access to a memory space. For example, one functional component may access data accessed by or transformed by another functional component. The functional components may be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implements a portion of the functional components). The systems, engines, or devices described may include additional, fewer, or different functional components for various applications.

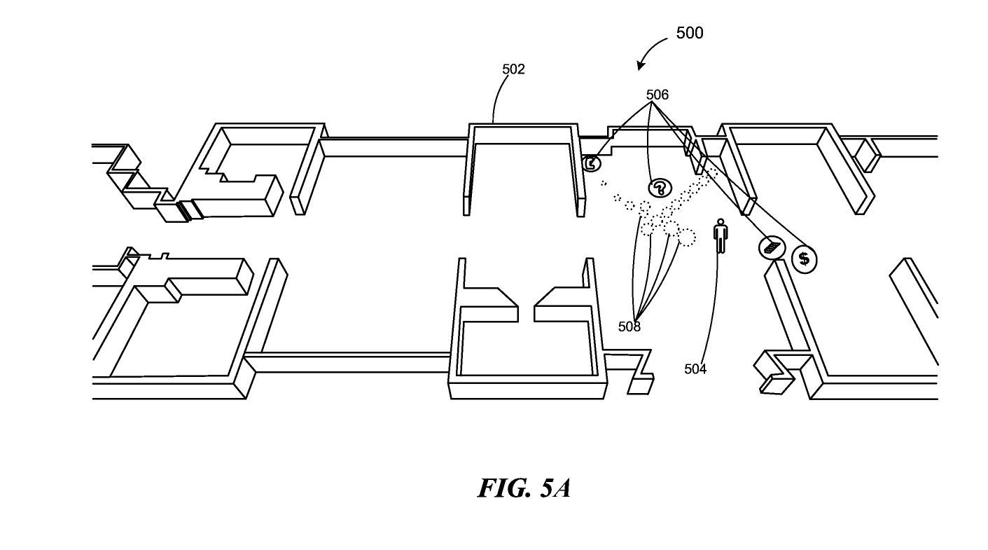

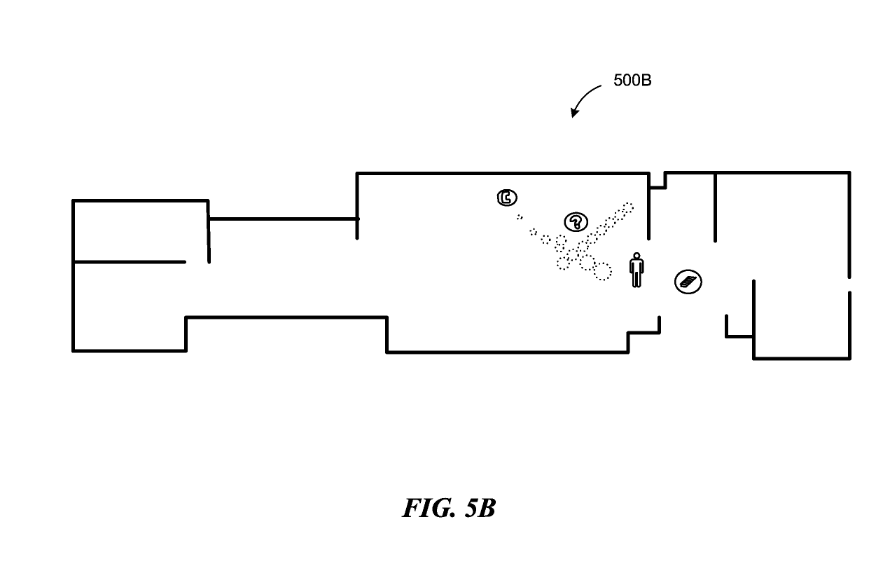

FIG. 5A is a perspective view illustration of a virtual simulation world 500 rendered by the location service application (e.g., the location service application 106 of FIG. 1), in accordance with various embodiments. For example, the virtual simulation world 500A can be rendered on an output component of the end-user device 108. The virtual simulation world 500A can include a virtual building 502 based on a physical map portion of a building model produced by the indoor navigation system 100. The virtual simulation world 500A can further include a user avatar 504 representing an end-user based on a calculated location determined by the location service application. For example, that calculation may be based on both the physical map portion and the RF map portion of the building model.

Some embodiments include a two-dimensional virtual simulation world instead. For example, FIG. 5B is a top view illustration of a virtual simulation world 500B rendered as a two-dimensional sheet by the location service application (e.g., the location service application 106 of FIG. 1), in accordance with various embodiments.

The virtual simulation world 500A can include building features 506, such as a public telephone, an information desk, an escalator, a restroom, or an automated teller machine (ATM). In some embodiments, the virtual simulation world 500A can include rendering of virtual RF sources 508. These virtual RF sources 508 can represent RF sources in the Physical World. The size of the virtual RF sources 508 can represent the signal coverage of the RF sources in the Physical World.

In this example illustration, the virtual simulation world 500A is rendered in a third person perspective. However, this disclosure contemplates other camera perspectives for the virtual simulation world 500A. For example, the virtual simulation world 500A can be rendered in a first person's perspective based on the computed location and orientation of the end-user. The virtual simulation world 500A can be rendered from a user selectable camera angle.

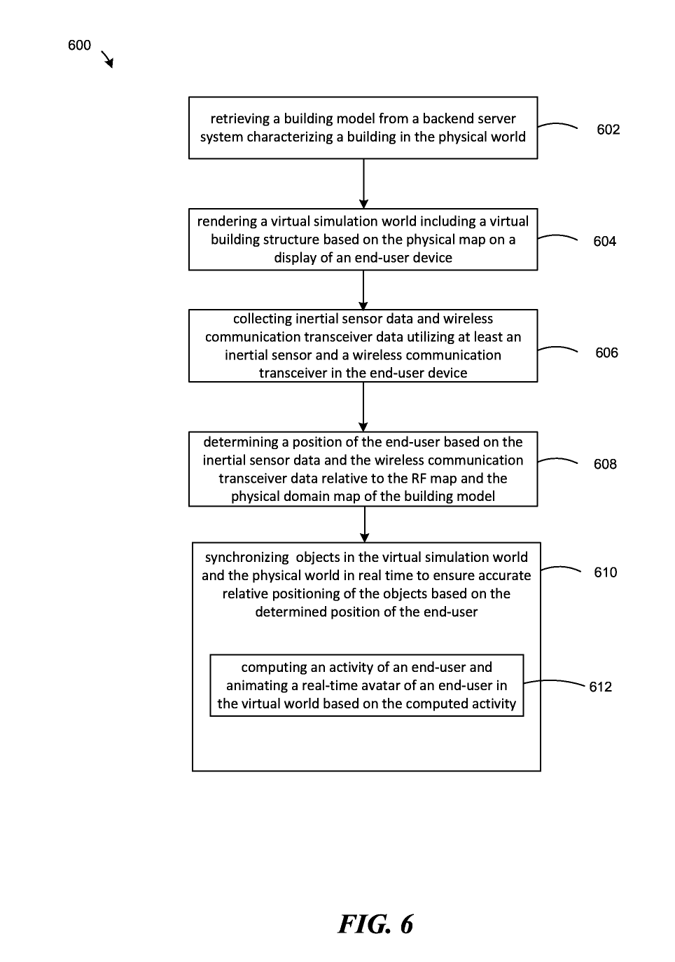

FIG. 6 is a flow chart of a method 600 of producing an immersive virtual simulation world correlated to the physical world in real-time, in accordance with various embodiments. The method 600 can be executed by a location service application running on an end-user device. At step 602, the end-user device retrieves a building model from a backend server system characterizing a building in the physical world. The building model can have multiple inter-related domains of characterization including, for example, a RF domain map, a virtual sensor domain map, and/or a physical domain map. In some embodiments, the virtual sensor domain map is the physical domain map. In some embodiments, the virtual sensor domain map is separate from the physical domain map, but each region and/or coordinate in the virtual sensor domain map correlates to a region and/or coordinate in the physical domain map. In some embodiments, the physical domain map is a three-dimensional map. The RF domain map can correlate directly or indirectly to the three-dimensional map.

At step 604, the end-user device can render a virtual simulation world including one or more virtual building structures based on the physical map on a display of an end-user device. At step 606, the end-user device can collect various domain-specific data, such as inertial sensor data, wireless communication transceiver data, and/or virtual sensor data utilizing, for example, an inertial sensor, a wireless communication transceiver, and/or a virtual sensor in the end-user device. In some embodiments, the wireless communication transceiver is configured according to a communication protocol. Collecting the wireless communication transceiver data can be performed during discovery phase of the communication protocol without engaging or authenticating with another communication device.

At step 608, the end-user device can determine a position of the end-user based on the domain-specific data relative to the domain-specific maps (e.g., the RF map, the physical domain map, and/or the virtual sensor map) of the building model. For example, the end-user device can determine the position by: computing a RF pattern based on the wireless communication transceiver data; matching the RF pattern to a location in the RF domain map; and determining the position from the physical domain map that is correlated to and aligned with the RF domain map in the building model.

At step 610, the end-user device synchronizes objects in the virtual simulation world and the physical world in real time to ensure accurate relative positioning of the objects based on the determined position of the end-user. For example, step 610 can include a sub-step 612. At sub-step 612, the end-user device computes an activity of an end-user by: determining a motion of the end-user based on the domain-specific data relative to the domain-specific maps; mapping the motion against an activity prediction model based on the position of the end-user relative to one or more known objects in the building model or a position of another user; and animating a real-time avatar of an end-user in the virtual world based on the computed activity.

A user can interact with the Physical World both with his/her physical body and a physical device that can provide additional senses that are not able to be sensed by the Physical User—e.g., magnetic field, RF, etc. The end-user device collects the kinetic movement of the Physical User and the end-user device as well as other sensor reading samples of the indoor environment (e.g., in the Physical World). All of these samples are used to determine the location and movement of the Physical User. Simultaneously, the real samples are provided to the virtual simulation world environment and the Virtual User is located in a correlated position within the associated Virtual Building and/or virtual simulation world. The Physical and virtual simulation worlds are tightly bound with correlations and confidences such that the Virtual User moves through the parallel virtual simulation world in near real time, mimicking the Physical User moving through the Physical World.

As an example scenario—a Physical User is within a specific physical room, perhaps the restroom, and the Virtual World has been correlating perfectly with the Physical World—indicating that same location within the 2D or 3D Virtual Building; but as the user walks out of the restroom through a physical back door—the Virtual Model is in error and does not have the back door. At this point, the two worlds are incoherent with each other. The Virtual User cannot simply pass through a model wall to another room. Furthering the scenario, the physical User is now in the family room of the building. The physical and RF sensors that are collecting within the User device are not consistent with the Virtual User's possible movements from the restroom—but are associated to a different room. The virtual location of the Virtual User is recalculated away from the expected virtual paths, and the Virtual User is recalculated to be in the family room. The User application detects the incoherence between the physical world and the virtual world and reports the discontinuity to the back end servers. The user application then changes the current location in the Virtual World to the newly detected room. The back end server system then evaluates the data from the User Device, and corrects the 2D or 3D model appropriately—adding a rear door to the 2D or 3D Virtual building such that subsequent users of the model will have a more accurate, tightly aligned virtual world to physical world.

The above scenario could be in the RF domain, such as when a new Wi-Fi access point has been installed in a physical building while a previous Wi-Fi access point has been retired. An end-user device might erroneously estimate the location of the User to be in a different room based on the RF signatures that are now different. Similar to the previous example, the Virtual User's path could contain discontinuities between the Virtual and Physical Worlds, and would report the discontinuities, including the RF collections that lead the Virtual User to defy physics, such as skip from the 3^{rd} floor to the 4^{th} floor without traversing stairs, elevator, or escalator. The back end servers would then analyze the data and correct the Virtual Building RF characteristics to correctly model the physical world for all users.

While processes or blocks are presented in a given order in FIG. 6, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

FIG. 7 is a block diagram of an example of a computing device 700, which may represent one or more computing device or server described herein, in accordance with various embodiments. The computing device 700 can be one or more computing devices that implement the indoor navigation system 100 of FIG. 1. The computing device 700 includes one or more processors 710 and memory 720 coupled to an interconnect 730. The interconnect 730 shown in FIG. 7 is an abstraction that represents any one or more separate physical buses, point-to-point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 710 is/are the central processing units (CPUs) of the computing device 700 and thus controls the overall operation of the computing device 700. In certain embodiments, the processor(s) 710 accomplishes this by executing software or firmware stored in memory 720. The processor(s) 710 may be, or may include, one or more programmable general-purpose or special-purpose microprocessors, digital signal processors (DSPs), programmable controllers, application specific integrated circuits (ASICs), integrated or stand-alone graphics processing units (GPUs), programmable logic devices (PLDs), trusted platform modules (TPMs), or the like, or a combination of such devices.

The memory 720 is or includes the main memory of the computing device 700. The memory 720 represents any form of random access memory (RAM), read-only memory (ROM), flash memory, or the like, or a combination of such devices. In use, the memory 720 may contain a code 770 containing instructions according to the mesh connection system disclosed herein.

Also connected to the processor(s) 710 through the interconnect 730 are a network adapter 740 and a storage adapter 750. The network adapter 740 provides the computing device 700 with the ability to communicate with remote devices, over a network and may be, for example, an Ethernet adapter or Fibre Channel adapter. The network adapter 740 may also provide the computing device 700 with the ability to communicate with other computers. The storage adapter 750 enables the computing device 700 to access a persistent storage, and may be, for example, a Fibre Channel adapter or SCSI adapter.

The code 770 stored in memory 720 may be implemented as software and/or firmware to program the processor(s) 710 to carry out actions described above. In certain embodiments, such software or firmware may be initially provided to the computing device 700 by downloading it from a remote system through the computing device 700 (e.g., via network adapter 740).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, tablet, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

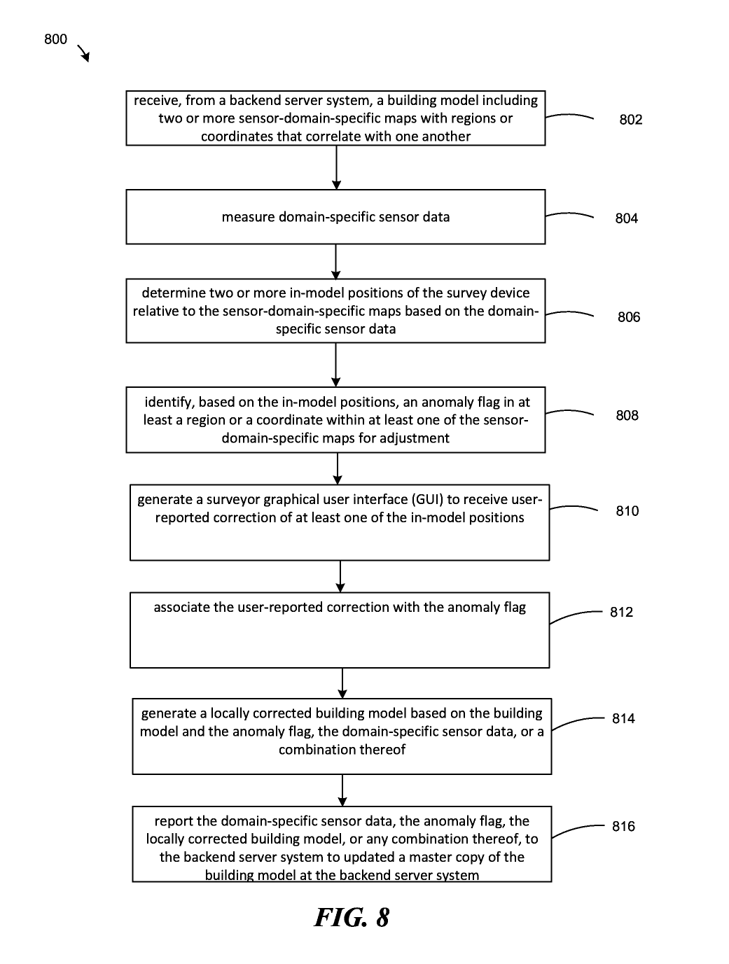

FIG. 8 is a flow chart of a method 800 of operating a surveyor device to generate or update a building model in a backend server system, in accordance with various embodiments. In various embodiments, the building model can be part of a site model. The surveyor device can be an electronic device having a general-purpose operating system running a surveyor application. For example, when updating a building model, at step 802, the surveyor device can receive, from a backend server system, the building model including two or more sensor-domain-specific maps with regions or coordinates that correlate with one another. The sensor-domain-specific maps can a physical map, a radio frequency (RF) map, or any combination thereof.

A surveyor user can utilize the surveyor device within a building to update or generate the building model associated with the building. At step 804, the surveyor device can measure domain-specific sensor data. The domain-specific sensor data can include inertial sensor data, magnetometer data, wireless radiofrequency (RF) data, or any combination thereof. The domain-specific sensor data can include virtual sensor data implemented by processing the in-model position through a physical simulation engine configured by the building model.

In some examples, the surveyor device can measure radiofrequency (RF) characteristics. In some embodiments, the surveyor device can generate or update an RF map of the building model. The surveyor device can report the generated or updated RF map to a backend server system. In some examples, the surveyor device can measure inertial sensor readings. In some embodiments, the surveyor device can generate or update a physical map of the building model. The surveyor device can report the generated or updated physical map to a backend server system. In various embodiments, each update to the RF map is associated with each update to the physical map captured at the same time or within the same time range. This way, the surveyor device can report the correlation between the RF map and the physical map back to the backend server system.

At step 806, the surveyor device can determine two or more in-model positions of the survey device relative to the sensor-domain-specific maps based on the domain-specific sensor data. At step 808, the surveyor device can identify, based on the in-model positions, an anomaly flag in at least a region or a coordinate within at least one of the sensor-domain-specific maps for adjustment.

At step 810, the surveyor device can generate a surveyor graphical user interface (GUI) to receive user-reported correction of at least one of the in-model positions. At step 812, the surveyor device can associate the user-reported correction with the anomaly flag. At step 814, the surveyor device can generate a locally corrected building model based on the building model and the anomaly flag, the domain-specific sensor data, or a combination thereof. At step 816, the surveyor device can report the domain-specific sensor data, the anomaly flag, the locally corrected building model, or any combination thereof, to the backend server system to update a master copy of the building model at the backend server system.

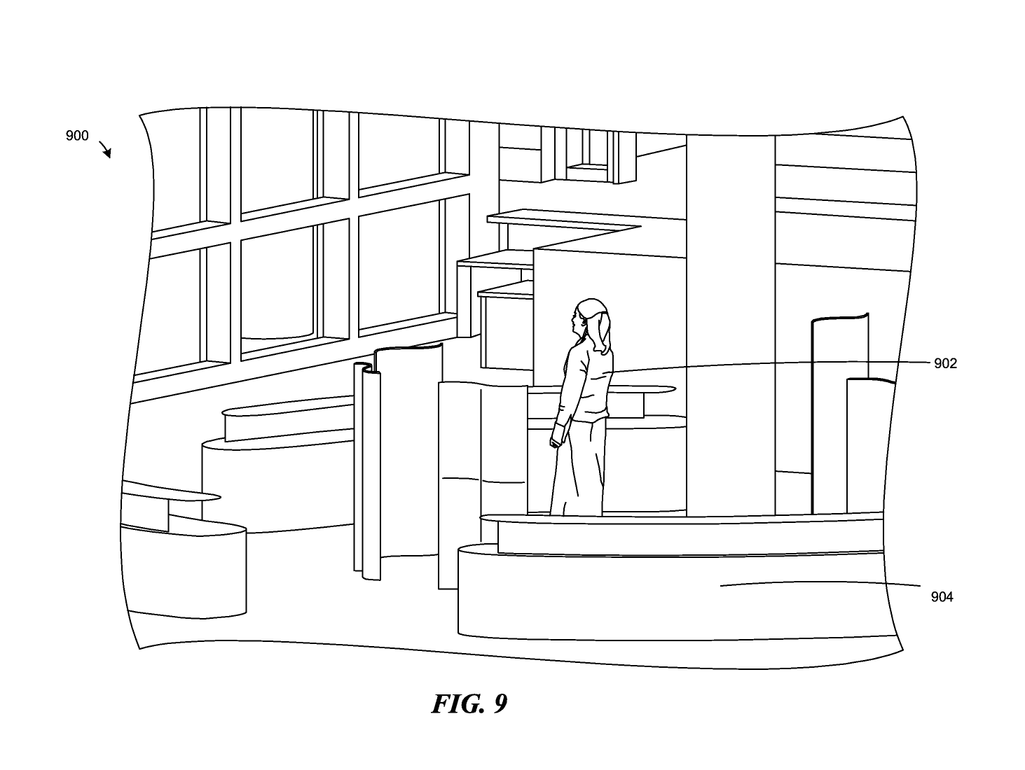

FIG. 9 is an example of a user interface 900 for an end-user device using the disclosed indoor navigation system to navigate through a known site, in accordance with various embodiments. In this example, the user interface 900 can be rendered from a third person perspective of an end-user operating the end-user device. The user interface 900 can include a rendering of an avatar 902 representing the position of the end-user relative to other objects in a site model of the known site. The site model can include one or more building models. Each of the building models can include one or more object models. For example, a table object 904 can be a rendering representative of a table in one of the building models. The user interface 900 provides correlated visual cues to facilitate navigation within the known site. As described above, the building models can be updated in various domains that are correlated with sensor data patterns observed by one or more surveyor devices and/or one or more end-user devices.

In other examples, a building model can include other objects, such as windows, fire extinguishers, containers, statues, building structures, fixtures, furniture, furnishings, obstacles, stairs, elevators, escalators, cabinets, or any combination thereof. The user interface 900 can render any combination of these objects when the location service application 106 or the backend server system 102 determines that these objects are within a proximity range that makes them visible to the end-user. The immersive visual cues can help the end-user orients him/herself because the end-user can see the relative geometric relationships among these objects and the end-user via the user interface 900.

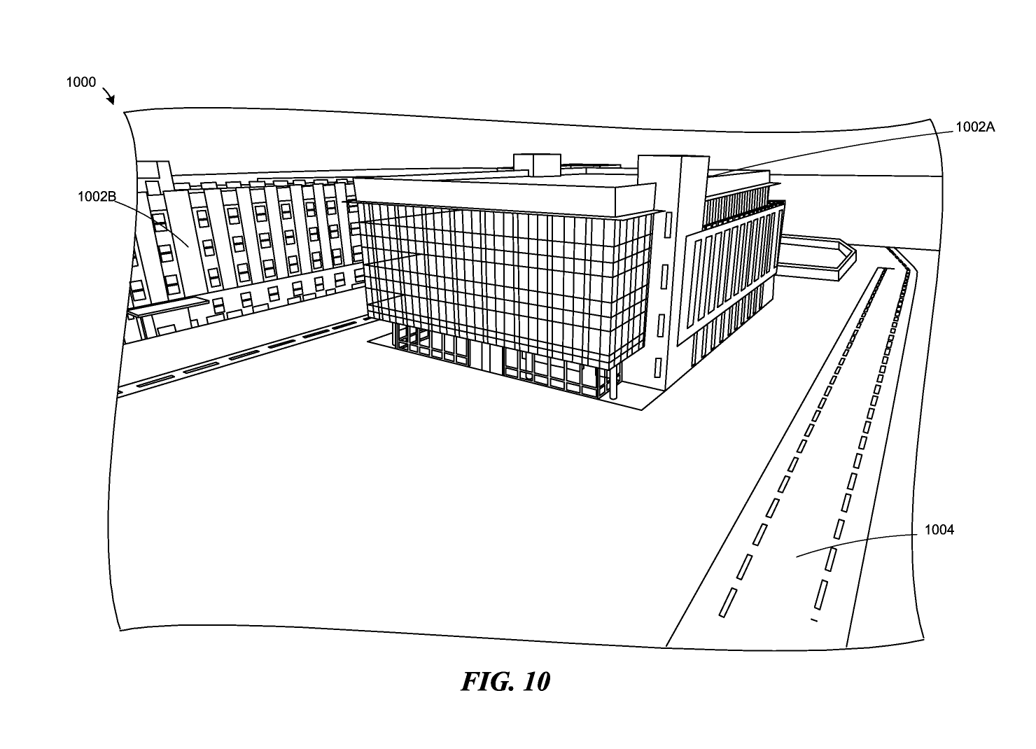

FIG. 10 is another example of a user interface 1000 for an end-user device using the disclosed indoor navigation system to navigate through a known site, in accordance with various embodiments. In this example, the user interface 1000 does not include a rendering of an avatar. For example, the user interface can be a first-person perspective instead of a third person perspective. The user interface 1000 can render a portion of a site model representative of the known site. The rendered portion can correspond to a portion determined by the indoor navigation system as being visible to an end-user operating the end-user device. The site model can include a building model 1002A and a building model 1002B, both of which are rendered in this example of the user interface 1000. The site model can also include a road object 1004, which although outdoors, is part of the site model.

Some embodiments of the disclosure have other aspects, elements, features, and steps in addition to or in place of what is described above. These potential additions and replacements are described throughout the rest of the specification.

1. A computer-implemented method comprising:
retrieving a building model from a backend server system, the building model characterizing a building in the physical world, wherein the building model has multiple inter-related domains of characterization including a radiofrequency (RF) domain map and a physical domain map;
rendering a virtual simulation world including a virtual building structure based on the physical domain map on a display of an end-user device;
collecting inertial sensor data and wireless communication transceiver data utilizing at least an inertial sensor and a wireless communication transceiver in the end-user device;
determining a position of the end-user device based on the inertial sensor data and the wireless communication transceiver data relative to the RF map and the physical domain map of the building model; and
synchronizing objects and collected sensor signatures in the virtual simulation world and the physical world in real time to ensure accurate relative positioning of the objects based on the determined position of the end-user device.

2. The computer-implemented method of claim 1, wherein the physical domain map is a three-dimensional map.

3. The computer-implemented method of claim 1, wherein the RF domain map correlates directly to the physical domain map such that a position in the RF domain map has a corresponding position in the physical domain map.

4. The computer-implemented method of claim 1, wherein the wireless communication transceiver is configured according to a communication protocol, and wherein collecting the wireless communication transceiver data is performed during discovery phase of the communication protocol without engaging or authenticating with another communication device.

5. The computer-implemented method of claim 1, wherein said synchronizing includes:
computing an activity of an end-user; and
animating a real-time virtual user of an end-user in the virtual world based on the computed activity.

6. The computer-implemented method of claim 5, wherein said computing the activity includes:
determining a motion of the end-user based on the inertial sensor data and the wireless communication transceiver relative to the RF map and the physical domain map; and
mapping the motion against an activity prediction model based on the position of the end-user relative to one or more known objects in the building model or a position of another user.

7. The computer-implemented method of claim 1, wherein said determining the position includes:
computing a RF pattern based on the wireless communication transceiver data;
matching the RF pattern to a location in the RF domain map; and
determining the position from the physical domain map that is correlated to and aligned with the RF domain map in the building model.

8. The computer-implemented method of claim 1, wherein said determining the position includes adjusting the position according to virtual sensor data implemented by a physics simulation engine configured by the building model.

9. A computer readable data memory storing computer-executable instructions that, when executed by a computer system, cause the computer system to perform a computer-implemented method, the instructions comprising:
receiving, from a backend server system, a building model including two or more sensor-domain-specific maps with regions or coordinates that correlate with one another;
measuring, via surveyor device, domain-specific sensor data;
determining two or more in-model positions of the survey device relative to the sensor-domain-specific maps based on the domain-specific sensor data; and
identifying, based on the in-model positions, an anomaly flag in at least a region or a coordinate within at least one of the sensor-domain-specific maps for adjustment.

10. The computer readable data memory of claim 9, wherein the sensor-domain-specific maps includes a physical map, a radio frequency (RF) map, or any combination thereof.

11. The computer readable data memory of claim 9, wherein the domain-specific sensor data includes inertial sensor data, magnetometer data, wireless radiofrequency (RF) data, camera sensor data, image recognition engine, microphone sensor, auditory recognition engine, or any combination thereof.

12. The computer readable data memory of claim 9, wherein the domain-specific sensor data includes virtual sensor data implemented by processing the in-model position through a physical simulation engine configured by the building model.

13. The computer readable data memory of claim 9, wherein measuring the domain-specific sensor data includes measuring radiofrequency (RF) characteristics to generate or update an RF map of the building model.

14. The computer readable data memory of claim 13, wherein the instructions further comprises reporting the generated or updated RF map to a backend server system.

15. The computer readable data memory of claim 9, wherein measuring the domain-specific sensor data includes measuring inertial sensor readings to generate or update a physical map of the building model.

16. The computer readable data memory of claim 15, wherein the instructions further comprises reporting the generated or updated physical map to a backend server system.

17. The computer readable data memory of claim 9, wherein the surveyor device is an electronic device having a general-purpose operating system running a surveyor application.

18. The computer readable data memory of claim 9, wherein the instructions further comprises reporting the domain-specific sensor data or the anomaly flag to the backend server system to update a master copy of the building model at the backend server system.

19. The computer readable data memory of claim 9, wherein the instructions further comprises:
generating a locally corrected building model based on the anomaly flag and the building model; and
reporting the locally corrected building model to the backend server system.

20. The computer readable data memory of claim 9, wherein the instructions further comprises:
generating a surveyor graphical user interface (GUI) to receive user-reported correction of at least one of the in-model positions; and
associating the user-reported correction with the anomaly flag.

21. A mobile device comprising:
a processor configured by executable instructions to:
retrieve a building model from a backend server system, the building model characterizing a building in the physical world, wherein the building model has multiple inter-related domains of characterization including a radiofrequency (RF) domain map and a physical domain map;
render a virtual simulation world including a virtual building structure based on the physical domain map on a display of an end-user device;
collect inertial sensor data and wireless communication transceiver data utilizing at least an inertial sensor and a wireless communication transceiver in the end-user device;
determine a position of the end-user device based on the inertial sensor data and the wireless communication transceiver data relative to the RF map and the physical domain map of the building model;
correcting the position utilizing a physics simulation engine; and
synchronize objects and collected sensor signatures in the virtual simulation world and the physical world in real time to ensure accurate relative positioning of the objects based on the determined position of the end-user device.
